(19) United States
(12) Patent Application Publication
(10) Pub. No.: US 2022/0210323 A1
(43) Pub. Date: Jun. 30, 2022

(54) PANORAMIC IMAGING VIA NETWORKED DEVICES

(71) Applicant: CLIQA SOCIAL LTD, Modiin (IL)

(72) Inventor: Hagit Hava YEDVAB, Modiin (IL)

(73) Assignee: CLIQA SOCIAL LTD, Modiin (IL)

(21) Appl. No.: 17/613,096

(22) PCT Filed: Jul. 5, 2020
(86) PCT No.: PCT/IL2020/050750

§ 371 Date: Nov. 22, 2021

Related U.S. Application Data
(60) Provisional application No. 62/871,209, filed on Jul. 8, 2019.

(51) Int. Cl. H04N 5/232

(52) U.S. Cl. CPC H04N 5/23238; H04N 5/23206; H04N 5/23232

(57) ABSTRACT

A method and/or system is disclosed for creating panoramic images from a group of networked devices. Optionally, the system will identify available recording devices located around an event. In some embodiments, the system will arrange for some level of control and/or access to the devices. For example, there may be a large number of people carrying cell phones in and around the event. Optionally, the system collects pictures from the different devices and make a collage recording of the event. For example, the system may recognize an event and/or be informed of an event. In some embodiments, the system will make a model (e.g. a 3D and/or 4D model) and/or supply the model in a way that allows a viewer to choose views and/or times and/or “walk through” the scene.

### RELATED APPLICATION/S

This application claims the benefit of priority under 35 USC § 119(e) of U.S. Provisional Patent Application No. 62/871,209 filed 8 Jul. 2019, the contents of which are incorporated herein by reference in their entirety.

### FIELD AND BACKGROUND OF THE INVENTION

The present invention, in some embodiments thereof, relates to a method and system for producing panoramic images and/or multidimensional models.

### SUMMARY OF THE INVENTION

According to an aspect of some embodiments of the invention, there is provided a method for producing panoramic images including: detecting a plurality of actors are producing images in a shared space, each actor of the plurality of actors using a respective image capture device connected to a communication network; collecting a plurality of images including a respective image from each respective image capture device; joining the plurality of images to form a panorama; posting the panorama.

According to some embodiments of the invention, the plurality of actors are independent, the method further including: sending a message over the respective image capture device requesting permission of each actor for the posting of the images.

According to some embodiments of the invention, the plurality of actors are members of a previously formed social network of image sharing.

According to some embodiments of the invention, the plurality of images are of a shared event.

According to some embodiments of the invention, the plurality of images include a landmark.

According to some embodiments of the invention, the method further includes collecting information from the respective image capture device about an image of the plurality of images.

According to some embodiments of the invention, the information includes at least one of a location where the image was made, a direction in which the image was made, a face recognized in the image and a time at which the image was taken.

According to some embodiments of the invention, the joining includes compensating for a difference in the information between two images of the plurality of images.

According to some embodiments of the invention, the panorama includes at least one of a composite image, a 3D model, a 4D model.

According to some embodiments of the invention, the method further includes: controlling an image capture device connected remotely using the communication network to produce a remote image and wherein the panorama includes the remote image.

According to some embodiments of the invention, the method further includes: controlling an image capture device worn by one of the plurality of actors connected remotely using the communication network to produce a remote image and wherein the panorama includes the remote image.

According to an aspect of some embodiments of the invention, there is provided a system for producing panoramic images including: a plurality of image capture devices with network communication hardware each device of the capture devices controlled by a respective actor; a central controller; a communication network connecting the plurality of image capture devices to the central controller and wherein the central controller is configured for: detecting when each respective actor produces an image in a shared space, collecting a plurality of images from the plurality of devices in response to the detecting, joining the plurality of images to form a panorama and posting the panorama.

According to some embodiments of the invention, each respective actor is independent, the central controller further configured for: sending a message over each respective actor requesting permission of each respective actor for the posting of the images.

According to some embodiments of the invention, each respective actor is a member of a previously formed social network of image sharing.

According to some embodiments of the invention, the plurality of images are of a shared event. According to some embodiments of the invention, each of the plurality of images includes a landmark.

According to some embodiments of the invention, the central controller is further configured for collecting information from the respective image capture device about an image of the plurality of images. According to some embodiments of the invention, the information includes at least one of a location where the image was made, a direction in which the image was made, a face recognized in the image and a time at which the image was taken.

According to some embodiments of the invention, the joining includes compensating for a difference in the information between two images of the plurality of images.

According to some embodiments of the invention, the panorama includes at least one of a composite image, a 3D model, a 4D model.

According to some embodiments of the invention, the system further includes: an image capture device controlled remotely over the communication network the central controller to produce a remote image and wherein the panorama includes the remote image.

According to some embodiments of the invention, the system further includes: a wearable image capture device at least one the respective actor and controlled remotely by the central controller using the communication network to produce a remote image and wherein the panorama includes the remote image.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java,

Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g. the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flow chart illustration of making a panorama in accordance with an embodiment of the current invention.

FIG. 2 is a schematic illustration of a scene and a combined recording in accordance with an embodiment of the current invention;

FIG. 3 is a flow chart illustration of a method of producing a combined image in accordance with an embodiment of the current invention;

FIG. 4 is a flow chart illustration of a method of producing a combined recording in accordance with an embodiment of the current invention;

FIG. 5 is a flow chart illustration of a method of producing a combined recording in accordance with an embodiment of the current invention; and

FIG. 6 is a block diagram illustration of a system for producing a combined recording in accordance with an embodiment of the current invention.

### DETAILED DESCRIPTION OF SOME EMBODIMENTS OF THE INVENTION

The present invention, in some embodiments thereof, relates to a method and system for producing panoramic images and/or multidimensional models.

### Overview

An aspect of some embodiments of the current invention relates to a method and/or system for creating panoramic images from a group of networked devices. Optionally, the system will identify available recording devices located around an event. In some embodiments, the system will arrange for some level of control and/or access to the devices. For example, there may be a large number of people carrying cell phones in and around the event. Optionally, the system collects pictures from the different devices and make a collage recording of the event. For example, the system may recognize an event and/or be informed of an event. For example, a group of people may be sitting around a table. Optionally, over time, different people take pictures of the event and/or the people sitting there at different angles. Optionally the system recognizes the relationship between the pictures and puts together a panoramic picture of the table and/or people who sat there. Alternatively or additionally, the system may track an object (e.g. person and/or an inanimate object) and supply pictures of the object from various cameras. Alternatively or additionally, moving pictures and/or sound may be supplied. In some embodiments, the system will make a model (e.g. a 3D and/or 4D model) and/or supply the model in a way that allows a viewer to choose views and/or times and/or “walk through” the scene.

In some embodiments, combined recordings may be based on stored objects (e.g. one or more personal and/or shared directories and/or photo albums). Alternatively or additionally, a combined recording may be created from recordings (e.g. images, videos and/or sound recordings) taken in real time (for example by members of a long-term and/or ad-hoc social network). In some embodiments, grouping and/or combining recordings may facilitate real-time & automatic group photo/video processing. (e.g. Slide-shows/collages/movies etc.).
In some embodiments, a system may recognize when album members take a picture simultaneously, and thus instantly create media which is formed by automatically combining such shared photos and/or videos, in order to form multi-dimensional photos and/or videos.
In some embodiments, a 360-degrees photograph may be formed. For example, a group of users may take simultaneous photos while sitting/standing, for example, in a circle/oval formation, For example, a panoramic image may be used like 360-degrees photography, where the camera turns around in the center of such circle. For example, a 360-degrees photo may be constructed out of many photos taken from the outside towards the inside of a circle.
The system will optionally test that the photos were all taken within a specific time delta, and/or within sufficient spatial scattering.
Simultaneous photographing action may be achieved by various methods:
   a) The users purposely take the photo together.
   b) An automated system and/or dedicated click by one user, automatically triggers other devices.
   c) A pre-set timer, automatically triggers periodic simultaneous automatic photo taking.
It is suggested to combine this feature with dedicated camera hardware, as to enable the dedicated hardware to be a small camera, attached to the user, as to not cover user's face, as would occur while photographing with a smartphone camera. For example, a lens of a cameral may worn (for example on a band [e.g. a wrist band] and/or pinned to clothes and/or on a pair of smart glasses) and/or placed on a stand on a table and/or on a floor.
Other use cases may not necessarily require that photos be taken at the same time or within a given time delta. Rather the system may output any processing result, which is made up of photos and/or videos taken at different time points at a given location, by the members of a given group.
Yet other use cases may not necessarily require that photos must be taken at the same location. Rather the system may output any processing result, which is made up of photos and/or videos taken in different locations, at the same time or within a given time delta, by the members of a given group.

### Detailed Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

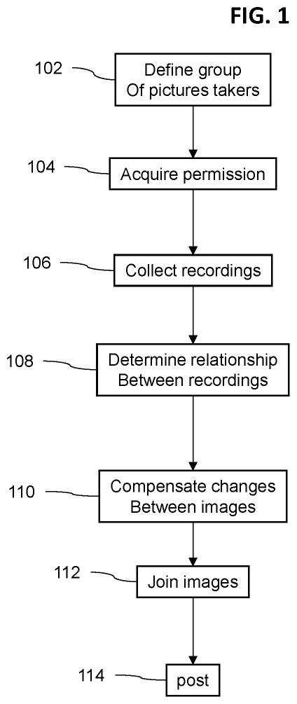

FIG. 1 is a flow chart illustration of making a panorama in accordance with an embodiment of the current invention. In some embodiments, the system will define 102 a group of recorders. Optionally, for example the recorders may include multiple people with networked cameras (e.g. cell phone cameras). For example, multiple people attending and/or multiple people taking pictures at an event. Alternatively or additionally, the recorders may include automated devices. For example, the system may also access security camera, and/or other recording devices. Alternatively or additionally, the recorders may include dedicated hardware and/or people. For example, the system may control a camera and/or an unmanned aerial vehicle (UAV) and/or the system may receive images from a professional photographer covering the event. In some embodiments, the system tracks activity and/or location of the recorders and/or collects recordings made by the recorders. Optionally, the system may know of an event and search for recording devices around the event. Alternatively or additionally, the system may recognize from behavior of a group of recorder owners that an event is occurring. For example, if a group of people take pictures of a scene and/or a known landmark over a short time period. In some embodiments, the system acquires 104 permission to retrieve images and/or make images using various devices located around the event. For example, the system may trigger a large number of devices to take a series of pictures simultaneously and/or send a message to camera owners, please “take a picture of this object now”. Over time, the system may collect 106 recordings from the various devices.

In some embodiments, the system determines 108 a relationship between recordings. For example, multiple images may be made of a scene that include overlapping portions. The images may be made at the same time and/or at close by time. Optionally, the system determines 108 relationships between recordings made by different devices. For example, the system may use location data from the device and/or landmarks in the pictures to determine 108 the location and/or field of view of each recording. Alternatively or additionally, the system may use movement data and/or position data of a first device that is in the field of view of an image made by a second device to determine 108 the position of the first device and/or identity of the owner of the first device in the image of the second device. Optionally a model of the scene is made (in 1D, 2D, 3D, 4D [for example in three spatial dimensions and time] or more dimensions). For example, a bunch of 2D images from different perspectives taken at the same time (e.g. an over a short enough time frame that there is not significant movement) are combined to make a panoramic view of a scene. For example, multiple images of the same place at different times may be used to make a collage in the time dimensions and/or images taken over time and space may be used to make a 4D collage (over time and 3D space). In some embodiments, images made be joined 112. For example, the joining may be made in a way that compensates 110 for effects of changes in perspective and/or changes over time. For example, if two people sat together, but there is no good picture containing both of them, the system may join 112 two pictures that were made at different times. The location of the seam between the pictures may be selected to include only inanimate objects that did not significantly move over the time difference. Thus, a picture is acquired showing the two people sitting together (as they did) even though the picture as a single image was not available and/or the exact picture includes details that did not actually occur simultaneously. For example, pictures taken from different viewpoints may be transposed to appear to have been taken from the same viewpoint and then joined 112. Optionally, details that are not visible from the original viewpoint may be joined 112 from another picture (for example, the other picture may have been taken from a different viewpoint and/or time). For example, a picture of a person who moved over a time period may be transposed back to a position where that person was at another time and inserted into an image taken at the other time. In some embodiments, joining 112 images may include building a 1D panorama and/or a 2D panorama and/or an artificial fisheye view and/or 2D time frames and/or building a model of the scene (e.g. in 3D and/or 4D).

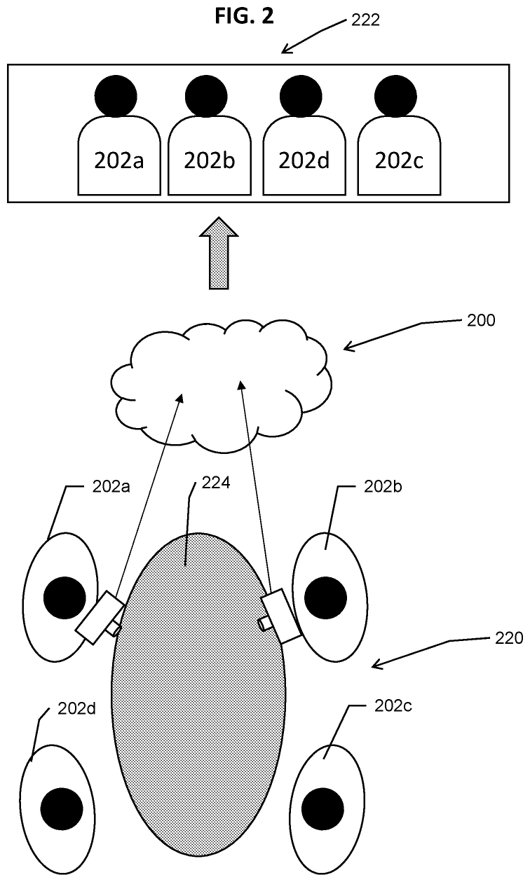

In some embodiments, the combined recordings may be posted 114. For examples, access to panoramic images and/or a multi-dimensional models may be sent over the network to individuals (e.g. the owners of the recording devices and/or a person responsible for an event [for example panoramic images may be put into photo album of a wedding and/or multidimensional images may be made into a video that is included in a video of a wedding that is eventually given to the new couple] and/or posted to a bulletin board [e.g. a Facebook page and/or shared on-line album etc.]) For example, combined recordings may be posted as panoramic photos and/or videos. Alternatively or additionally, combined recordings may be posted as multidimensional models. For example, a 3D model of a scene may be posted allowing people to manipulate the model, for example to look at the scene from different perspectives and/or to “walk through” the scene and/or to follow a certain person or object. Alternatively or additionally, a 4D model may allow people to manipulate and/or view a scene from different viewpoints and/or over different times. FIG. 2 is a schematic illustration of a scene 220 and a combined recording (e.g. a 2D panoramic image 222) in accordance with an embodiment of the current invention. For example, a scene may include a lot of details. Various people may record images of various parts of the scene wherein no one image captures the scene completely. Optionally, a system will have access to the images, for example over a network. For example, the various people taking pictures may be members of a shared social network and/or may be put together an ad-hoc network. In some embodiments, the system will combine recordings (e.g. images) to make panoramic recordings of the scene.

In an exemplary scene, four people 202a, 202b, 202c, 202d sitting around a table 224 (for example in a wedding and/or another memorable event). Two of the people 202a, 202b have network enabled image capturing devices. Optionally, a system 200 recognizes that this is a shared scene and/or connects the recording devices of people 202a, 202b into an ad-hoc network and/or gets permission from people 202a, 202b to use their images. For example, one or more pictures taken by each person 202a, 202b are uploaded to the system 200 (e.g. over a network) and/or combined (optionally with compensation for changes in viewpoint etc.) to create a panoramic image 222 including all of the people 202a, 202b, 202c, 202d sitting around the table in a single image.

In some embodiments, the system creates an inverse panoramic photo. For example, a conventional panoramic photo is made when a camera in the middle of a scene turns on its axis to take a series of pictures around the camera location. For example, in some embodiments an inverse panorama is created when images taken at various locations in and/or around the periphery of a circle/oval and/or other formation are put together. For example, a 360-degrees photograph may be formed. Instead of common 360-degrees photography, where the camera turns around in the center of such circle, the 360-degrees photo will be constructed out of many photos taken from the outside towards the inside of such circle.

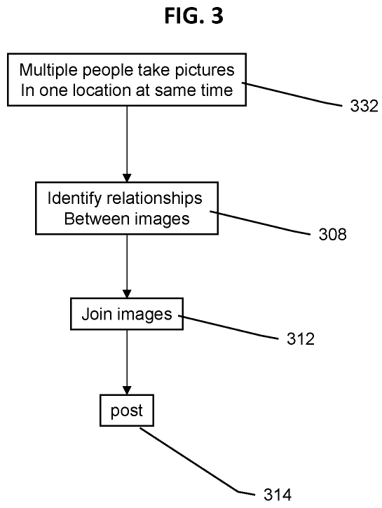

FIG. 3 is a flow chart illustration of a method of producing a combined image in accordance with an embodiment of the current invention. In some cases, a plurality of people will take 332 a picture of a scene at the same time (and/or nearly at the same time). For example, multiple people may take 332 pictures in a kindergarten end of the year production and/or at a posed group photograph and/or during dancing at a wedding and/or when a group of tourists visits an attraction etc. Optionally, the pictures be saved at a previously selected location and/or the system will use pictures taken 332 previously and/or located at a defined storage location (for example, the event/wedding/concert/attraction may have a dedicated network for groups to collect together their photos and/or a tour group may have a prearranged photo sharing site and/or a family may have a shared album etc.). Alternatively or additionally, a system may recognize that a lot of pictures are being taken 332 at a single location by a lot of people (for example, the people may be subscribed to a recording combining application). Recognizing the potential of a panoramic image, a system may identify 308 a relationship between various images and/or their fields of view and/or join 312 images and/or compensate for differences between images. Optionally, the system will output a panoramic images and/or post 314 it to individuals and/or to a group album. For example, the images may be sent to people who appear in the image, people who added material for the image, an organizer of an event, other people (relatives, police, security, advertisers etc.)

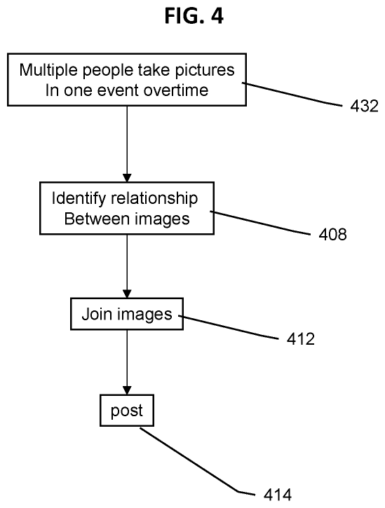

FIG. 4 is a flow chart illustration of a method of producing a combined recording in accordance with an embodiment of the current invention. In some cases, multiple devices will be taking 432 recordings of an event. Optionally, a system will identify that there is an event occurring. For example, the system may be triggered by an event organizer and/or the system may search for event announcements (e.g. over the Internet) and/or the collection of people in one place may prompt the system to recognize that some sort of event is occurring. Optionally, the system will request from owners of various devices present at the event to access their recordings and/or for limited remote control of their devices. The system will optionally identify places and/or times where it would be desirable to have recordings and/or fill in existing recordings. Optionally the system will trigger devices in the desired places to record. For example, the system may start recording on a cellular device of a person when he is standing at a location which is underserved by other recordings The system optionally identifies 408 relationships between images (same/different person/object, same/different location, same/different time). The system, may remotely trigger capturing recordings. Optionally, the system joins 412 spontaneously taken recordings with fill in recordings taken under control of the system to produce a combined recording (e.g. a panoramic image, 3D model and/or 4D model). Optionally the combined recording may then be posted 414. For example, the image may be made available to an organizer of the event. For example, the image may be made available to people who allowed the system to access their devices and/or pictures. For example, the image may be made available to people who appear in the images and/or attended the event. For example, the image may be made available to security personal such as the police. For example, the image may be made available to professionals for example coaches who may offer their services teaching dance, social skills, etc. to members of the event and/or to event planners to improve planning of future events. For example, the image may be made available via advertising and/or to advertisers for example to advertise products to people in the event based on their behavior and/or to event planners based on needs recognized in the recording.

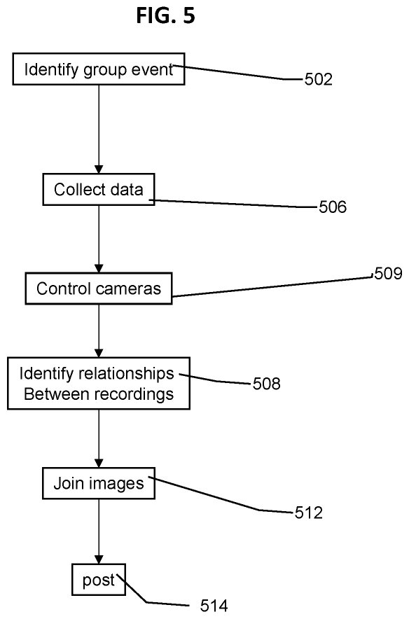

FIG. 5 is a flow chart illustration of a method of producing a combined recording in accordance with an embodiment of the current invention. In some embodiments, a central controller will recognize 502 a group event. For example, the central controller may include a cell phone of a member of a group of people sitting together at a restaurant. The cellphone is optionally programmed to recognize when a group of people remain in close vicinity to the cellphone over an extended period of time (for example more than 5 minutes and/or more than 20 minutes and/or more than 30 minutes. For example, the vicinity may be within 5 meters and/or within 20 meters and/or withing 50 meters. Optionally the size of the group and/or the length of time needed to trigger sharing may increase with increasing area. Alternatively or additionally, a local network device (for example, a WiFi device at a restaurant) may recognize groups. Optionally groups may be recognized amongst a pre-exiting network (for example a group of friends who tie themselves together for conditional photo sharing and/or a tour group). Optionally, a controller may include a device owned by a sports team getting images of a sporting event for use in analysis and/or the controller may be used by law enforcement officials.

In some embodiments, the controller will collect 506 up data from the collection of cameras. For example, the data may include the images that are made and/or meta data such as the direction in which the camera was pointed, the time, and/or the location of the camera when the picture was taken. Optionally, stored images may be collected. For example, a controller may combine an image of a person and/or a landmark to a panorama of including the landmark and/or person. For example, the picture available from a memory available over the network may be of higher quality than the images from network cameras.

In some embodiments, a central controller may control 509 remote controlled cameras. For example, attendees at an event may be given wearable cameras (for example worn on a neck chain optionally along with a name tag) and/or cameras may be supplied at various locations around an event center. Optionally, controlling 509 a camera may include taking an image when the camera is located at a time and/or location where more data is needed and/or collected data from the camera when the camera is at a time and/or location where data is needed.

In some embodiments, the controller will identify 508 relationships between images. For example, the controller may identify 508 a set of images including a particular person and/or object over time. For example, the controller may identify 508 a set of images that cover a certain space over time and/or from one or more viewpoints.

In some embodiments, images are joined 512. For example, images made be made into a panoramic picture and/or a 3D and/or 4D panoramic model of an event.

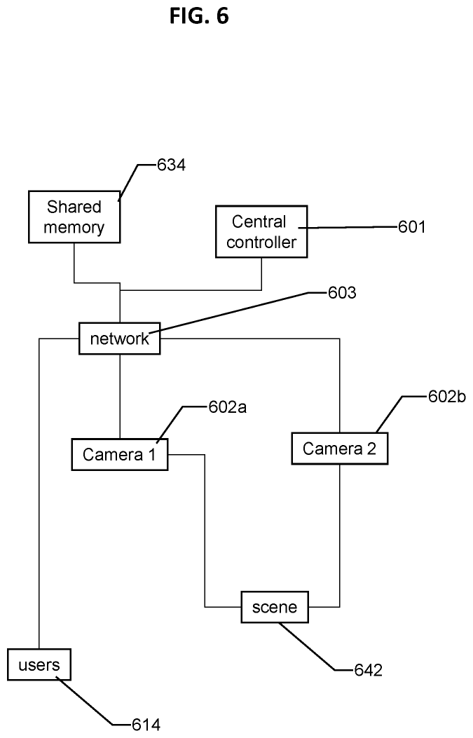

In some embodiments, the resulting output of the joining 512 (e.g. a panoramic picture and/or panoramic model) may be posted 514 to users. For example, some access may be supplied for free to attendees who participated in image collection 506. Some pictures and/or models may be shared publicly. Optionally, access to some pictures and/or models may be sold. Alternatively, access to data may be given to an event organizer and/or an authority and/or an interested party (for example a coach of a team at a sporting event and/or a performer in a production). FIG. 6 is a block diagram illustration of a system for producing a combined recording in accordance with an embodiment of the current invention. In some embodiments, a central controller 601 may receive image data from a group of imaging devices (e.g. cameras 602a, 602b) over a network 603. Optionally, the central controller itself may include an imaging device and/or may itself produce images. For example, the imaging devices may include an electronic camera, a cell phone, a security camera, a video camera, a UAV, a dedicated camera. The imaging devices may include dedicated equipment (which is optionally controlled by the central controller) and/or independent devices (for example cell phones belonging to individuals). The central controller 601 may include a cellphone and/or a computer server and/or a remote device. Optionally, the imaging devices make images of one or more scenes 642 and/or the central controller 601 collects up the images and/or combines a plurality of images to make a composite panorama (for example a panoramic picture and/or a 3D and/or 4D model of the scene 642 and/or scenes). Optionally, the central controller posts the panorama. For example, the panorama may be placed on shared memory 634. For example, the shared memory may be accessible over the network. Optionally, the central controller 601 will give access permission to the panorama to the owners of the imaging devices and/or selected users 614. For example, the controller 601 may send a link over the network to a user 614.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

It is expected that during the life of a patent maturing from this application many relevant technologies (for example, communication, user interfaces, automatic package scanning and identification, automatic package handling) will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for producing panoramic images comprising:
detecting a plurality of actors are producing images in a shared space, each actor of said plurality of actors using a respective image capture device connected to a communication network;
collecting a plurality of images including a respective image from each said respective image capture device;
joining said plurality of images to form a panorama;
posting said panorama.

2. The method of claim 1, wherein said plurality of actors are independent, the method further comprising:
sending a message over said respective image capture device requesting permission of said each actor for said posting of said images.

3. The method of claim 1, wherein said plurality of actors are members of a previously formed social network of image sharing.

4. The method of claim 1, wherein said plurality of images are of a shared event.

5. The method of claim 1, wherein said plurality of images include a landmark.

6. The method of claim 1, further comprising collecting information from said respective image capture device about an image of said plurality of images.

7. The method of claim 6, wherein said information includes at least one of a location where the image was made, a direction in which the image was made, a face recognized in the image and a time at which the image was taken.

8. The method of claim 7, wherein said joining includes compensating for a difference in said information between two images of said plurality of images.

9. The method of claim 1, wherein said panorama includes at least one of a composite image, a 3D model, a 4D model.

10. The method of claim 1, further comprising:
controlling an image capture device connected remotely using said communication network to produce a remote image and wherein said panorama includes said remote image.

11. The method of claim 1, further comprising:
controlling an image capture device worn by one of said plurality of actors connected remotely using said communication network to produce a remote image and wherein said panorama includes said remote image.

12. A system for producing panoramic images comprising:
a plurality of image capture devices with network communication hardware each device of said capture devices controlled by a respective actor;
a central controller;
a communication network connecting said plurality of image capture devices to said central controller and
wherein said central controller is configured for:
detecting when each said respective actor produces an image in a shared space, collecting a plurality of images from said plurality of devices in response to said detecting,
joining said plurality of images to form a panorama and
posting said panorama.

13. The system of claim 12, wherein each said respective actor is independent, the central controller further configured for:
sending a message over each said respective actor requesting permission of said each said respective actor for said posting of said images.

14. The system of claim 12, wherein each said respective actor is a member of a previously formed social network of image sharing.

15. The system of claim 12, wherein said plurality of images are of a shared event.

16. The system of claim 12, wherein each of said plurality of images includes a landmark.

17. The system of claim 12, wherein said central controller is further configured for collecting information from said respective image capture device about an image of said plurality of images.

18. The system of claim 17, wherein said information includes at least one of a location where the image was made, a direction in which the image was made, a face recognized in the image and a time at which the image was taken.

19. The system of claim 18, wherein said joining includes compensating for a difference in said information between two images of said plurality of images.

20. The system of claim 12, wherein said panorama includes at least one of a composite image, a 3D model, a 4D model.

21. The system of claim 12, further comprising:
an image capture device controlled remotely over said communication network said central controller to produce a remote image and wherein said panorama includes said remote image.

22. The system of claim 12, further comprising:
a wearable image capture device at least one said respective actor and controlled remotely by said central controller using said communication network to produce a remote image and wherein said panorama includes said remote image.
